(19) United States
(12) Patent Application Publication
(10) Pub. No.: US 2015/0034555 A1
(43) Pub. Date: Feb. 5, 2015

(54) Treatment of De-Oiled Oilfield Produced Water or De-Oiled Process Affected Water From Hydrocarbon Production

(71) Applicants: Brian C. Speirs, Calgary (CA); Bruce K. Bartlett, Calgary (CA); Amitava Sarkar, Calgary (CA); Olusola B. Adeyinka, Calgary (CA)

(72) Inventors: Brian C. Speirs, Calgary (CA); Bruce K. Bartlett, Calgary (CA); Amitava Sarkar, Calgary (CA); Olusola B. Adeyinka, Calgary (CA)

(21) Appl. No.: 14/272,869

(22) Filed: May 8, 2014

(30) Foreign Application Priority Data
Aug. 1, 2013 (CA) 2822605

(51) Int. Cl. C02F 9/00; B01D 71/34; B01D 71/36; C02F 1/42; C02F 1/44

(52) U.S. Cl. CPC C02F 9/00; C02F 1/42; C02F 1/444; B01D 71/36; B01D 71/34; C02F 1/441; C02F 1/442; C02F 2001/425; C02F 2001/422
USPC 210/638; 210/681; 210/683; 210/663; 210/668

(57) ABSTRACT

Generally, the present disclosure provides a process for treating de-oiled oilfield produced water or de-oiled process affected water from hydrocarbon production. In particular, such water is treated with a regenerable polymeric ion exchange resin to remove water soluble ionic surfactants. The treating can involve ion-exchanging ionic polymeric membrane foulants with non-fouling soluble ionic species that can be removed by polymeric membrane.

### CROSS REFERENCE TO RELATED APPLICATIONS

This application claims the priority benefit of Canadian Patent Application Number 2,822,605 filed Aug. 1, 2013 entitled TREATMENT OF DE-OILED OILFIELD PRODUCED WATER OR DE-OILED PROCESS AFFECTED WATER FROM HYDROCARBON PRODUCTION, the entirety of which is incorporated by reference herein.

### FIELD

The present disclosure relates generally to treating oilfield produced water or process affected water from hydrocarbon production.

### BACKGROUND

This background section is provided to assist the reader in understanding the present disclosure and is not necessarily prior art.

“Produced water” is water separated from oil-water mixtures from a subsurface hydrocarbon reservoir. Produced water may include water from the reservoir, water that has been injected into the formation, and may also include any additives added during production or treatment. As such, the composition of produced waters from different reservoirs and from different production processes is variable.

“Process affected water” is water from a hydrocarbon surface mining operation and may include additives or natural surfactants released during the extraction process.

In-situ heavy oil operations may involve injecting steam into a subsurface heavy oil reservoir. As used herein, “heavy oil” includes bitumen. The heat reduces the viscosity of the oil and the water dilutes and separates the oil from the sand. An oil-water mixture flows back to the wellbore where it is produced to the surface. Oil is separated from the oil-water mixture to form produced water. Produced water may contain residual emulsified oil and is commonly further de-oiled. Organic compounds and inorganic solids in the form of ions dissolved from the underground reservoir are pumped along with the oil-water mixture and form part of the produced water. The combined content of all organic and inorganic substances contained in de-oiled produced water is referred to as the total dissolved solids (TDS). Water hardness and silica are some of many inorganic components that make up TDS. Water hardness is determined by the concentration of positively charged ions (i.e. cations) with a charge greater than 1 (i.e. multivalent) in the water. The most common multivalent cations found in hard water are Ca²⁺ and Mg²⁺. While high TDS may indicate elevated levels of water hardness and silica, simultaneous reduction of TDS, hardness, and silica is usually required to mitigate scaling problems in steam generators or other downstream equipment. Scale build-up reduces performance, adding to maintenance costs of steam generators.

De-oiling compounds (e.g. soluble ionic surfactants) may be used to assist in the separation of produced water from the oil-water mixture or during a polishing step. It is generally desirable to further treat de-oiled produced water, for instance to produce high quality boiler feed water (BFW), for instance for use in drum boilers. To do so, it is necessary to reduce the total dissolved solids (TDS), silica, and hardness in the produced water.

One proposed solution for treating de-oiled produced water includes the use of hot or warm lime-softening (HLS or WLS), and weak acid cation exchange. A variety of chemicals are commonly required to reduce hardness and silica in this process. Additionally, such a process does not treat the salinity in the produced water which results in TDS build-up over time. In some recent applications, evaporator-crystallizer (EC) technology has been implemented, which requires the use of chemicals and operation at temperatures above the boiling point of water.

Another proposed technology for treating de-oiled produced water to remove dissolved solids is polymeric membrane filtration. However, polymeric membranes are significantly limited by fouling caused by residual de-oiling compounds (e.g. water soluble ionic surfactants), as well as organic macromolecules (e.g. tannins, humic acids, and fulvic acids) in the produced water.

It is desirable to provide an alternate process for treating de-oiled produced water or process affected water from hydrocarbon production.

### SUMMARY

It is an object of the present disclosure to obviate or mitigate at least one disadvantage of previous processes.

By treating de-oiled oilfield produced water or de-oiled process affected water from hydrocarbon production to remove water soluble ionic surfactants, one can produce a stream that can be treated by polymeric membranes. In particular, the de-oiled produced water is treated with a regenerable polymeric ion exchange resin to selectively remove water soluble ionic surfactants that foul polymeric membranes.

The treating can involve ion-exchanging ionic polymeric membrane foulants with non-fouling soluble ionic species that can be removed by polymeric membranes.

According to one aspect, there is provided a process for treating de-oiled oilfield produced water or de-oiled process affected water from hydrocarbon production, comprising: providing the de-oiled water; and treating the de-oiled water with a regenerable polymeric ion exchange resin to selectively remove foulants that foul polymeric membranes, wherein the foulants comprise a water soluble ionic surfactant.

Other aspects and features of the present disclosure will become apparent to those ordinarily skilled in the art upon review of the following description in conjunction with the accompanying figures.

### BRIEF DESCRIPTION OF THE DRAWINGS

Embodiments of the present disclosure will now be described, by way of example only, with reference to the attached Figures.

FIG. 1 is a schematic of a process.

### DETAILED DESCRIPTION

Generally, the present disclosure provides a process for treating de-oiled oilfield produced water or de-oiled process affected water from hydrocarbon production. In particular, the de-oiled water is treated with a regenerable polymeric ion exchange resin to remove water soluble ionic surfactants. The treating can involve ion-exchanging ionic polymeric membrane foulants with non-fouling soluble ionic species that can be removed by polymeric membrane.

The ionic nature of polymeric membranes and their interaction with water soluble ionic surfactants and organic macromolecules is understood to cause polymeric membrane fouling.

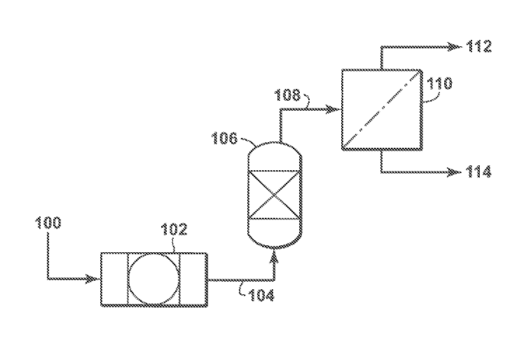

FIG. 1 is a schematic of a process to treat de-oiled oilfield produced water or process affected water from hydrocarbon production. FIG. 1 also illustrates a de-oiling step and a polymeric membrane filtration step. Oilfield produced water or process affected water from hydrocarbon production (100) is fed into a de-oiling system (102) to produce de-oiled water (104). As described above, de-oiling compounds (e.g. soluble ionic surfactants) (not shown) may be used to assist de-oiling. As noted above, the de-oiling step may involve multiple steps. The de-oiled water (104) may include residual de-oiling compounds, as well as organic macromolecules, both of which may cause fouling downstream, for instance in a polymeric membrane system. The de-oiled water (104) is then treated with a regenerable polymeric ion exchange resin (106), to remove foulants which may foul polymeric membranes. The now treated water (108) may be suitable as a polymeric membrane feed. As illustrated, the now treated water (108) is fed into a polymeric membrane system (110). The polymeric membrane system produces a permeate (112) and a concentrate (114). The permeate (112) may be suitable as quality boiler feed water (BFW), for instance for use in drum boilers.

Produced Water

“Produced water” is water separated from oil-water mixtures from a subsurface hydrocarbon reservoir. Produced water may include water from the reservoir, water that has been injected into the formation, and may also include any additives added during production or treatment. As such, the composition of produced waters from different reservoirs and from different production processes is variable.

Various hydrocarbon production techniques exist, depending in part on the nature of the reservoir. While the produced water is in no way limited to water produced during in-situ oil sands operations, such operations do produce large volumes of produced water and therefore will be used as an example herein.

In order to provide further context to the produced water from in-situ oil sands processes, a brief description of some in-situ oil sands processes will now be provided.

Where deposits lie well below the surface, bitumen may be extracted using in-situ (“in place”) techniques. One example of an in-situ technique is the steam-assisted gravity drainage method (SAGD). In SAGD, directional drilling is employed to place two horizontal wells in the oil sands, a lower well and an upper well positioned above it. Steam is injected into the upper well to heat the bitumen and lower its viscosity. The bitumen and condensed steam will then drain downward through the reservoir under the action of gravity and flow into the lower production well, whereby these liquids can be pumped to the surface. At the surface of the well, the condensed steam and bitumen are separated, and the bitumen is diluted with appropriate light hydrocarbons for transport to a refinery or an upgrader. An example of SAGD is described in U.S. Pat. No. 4,344,485 (Butler).

In other processes, such as in Cyclic Steam Stimulation (CSS), the same well is used both for injecting a fluid and for producing oil. In CSS, cycles of steam injection, soak, and oil production are employed. Once the production rate falls to a given level, the well is put through another cycle of injection, soak, and production. An example of CSS is described in U.S. Pat. No. 4,280,559 (Best).

Steam Flood (SF) involves injecting steam into the formation through an injection well. Steam moves through the formation, mobilizing oil as it flows toward the production well. Mobilized oil is swept to the production well by the steam drive. An example of steam flooding is described in U.S. Pat. No. 3,705,625 (Whitten).

Other thermal processes include Solvent-Assisted Steam Assisted Gravity Drainage (SA-SAGD), an example of which described in Canadian Patent No. 1,246,993 (Vogel); Vapour Extraction (VAPEX), an example of which is described in U.S. Pat. No. 5,899,274 (Frauenfeld); Liquid Addition to Steam for Enhanced Recovery (LASER), an example of which is described in U.S. Pat. No. 6,708,759 (Leaute et al.); and Combined Steam and Vapour Extraction Process (SAVEX), an example of which is described in U.S. Pat. No. 6,662,872 (Gutek), and derivatives thereof.

Process Affected Water

“Process affected water” is water from a hydrocarbon surface mining operation and may include additives or natural surfactants released during the extraction process.

De-oiling

Oil is separated from the oil-water mixture from in-situ oil sand processes to form produced water. By way of background, this oil dewatering process involves gravity separation using an API (American Petroleum Institute) oil-water-separator. The design of such separators is based on the specific gravity difference between the oil and the water. Most of the suspended solids will settle to the bottom of the separator as a sediment layer, oil will rise to top of the separator, and water will be the middle layer between the oil on top and the solids on the bottom. Produced water recovered from the middle of the oil-water separator may contain residual emulsified oil and is commonly further de-oiled in a number of stages so that both the oil and the water can be used. Produced water de-oiling may involve a combination of techniques including, for instance, skimmer tanks and vessels, plate coalescence, enhanced coalescence, enhanced gravity separation (e.g. hydrocyclones and centrifuges), flotation separation, adsorption/filtration, and membrane filtration.

De-oiling Compounds

“De-oiling compounds” may be used to assist de-oiling. De-oiling compounds may include surfactants, soluble ionic surfactants, emulsion breakers, reverse emulsion breakers, coagulants, flocculants, and wetting agents.

By way of background, there are two types of emulsions, normal and reverse, and both exist in oil production. In a normal emulsion, water droplets are dispersed in the continuous oil phase. In a reverse emulsion, oil droplets are suspended in the continuous water phase. In SAGD operations, for instance, oil-in-water emulsions are produced and may be broken using reverse emulsion breakers.

At least three types of chemical compounds are commonly used as normal emulsion breakers, oxyalklated resins, polyglycol esters, and alkyl aryl sulfonates.

Commonly used compounds for reverse emulsion treatment include polyamines, polyamine quaternary compounds, polyacrylates and thiocarbamates. More specifically, commonly used reverse emulsion-breaking chemicals, or water clarifiers, include the following: tridithiocarbamic acids (U.S. Pat. No. 5,152,927); dithiocarbamic salts (U.S. Pat. No. 5,247,087); dimethylaminoethyl acrylate methyl chloride and/or benzyl chloride quaternary salts (U.S. Pat. No. 5,643,460); polymeric quaternary ammonium betaines (U.S. Pat. No. 3,929,635); and metal salts (zinc chloride, aluminum chloride). Polymeric quaternary ammonium salts and copolymers of acrylic acid and acrylamide have also been used.

Wetting agents are generally used to improve solids removal.

Water soluble ionic surfactants are commonly used in CSS or SAGD produced water treatment operations. Attempts of CSS or SAGD produced water treatment by reverse osmosis technology to generate boiler feed water specification has been proven unsatisfactory in a lab and in a field pilot study. In particular, reverse osmosis membranes may produce high quality permeate but the detrimental effect of residual oil, residual de-oiling compounds, as well as organic macromolecules present in the produced water on permeate flux obtainable in reverse osmosis membranes has been established in a lab study.

Regenerable Polymeric Ion Exchange Resin

The de-oiled produced water may be treated with a regenerable polymeric ion exchange resin. The treating can involve ion-exchanging ionic polymeric membrane foulants with non-fouling soluble ionic species that can be removed by polymeric membranes. The resin should be effective in achieving the desired ion exchange in order to mitigate fouling in the polymeric membranes. The resin is used to ion exchange the residual de-oiling compounds (e.g. water soluble ionic surfactants), and may also be used to ion exchange organic macromolecules (e.g. tannins, humic acids, and fulvic acids), which may lead to fouling in polymeric membrane systems.

Ion exchange is the reversible interchange of ions between a solid (the ion exchange resin) and a liquid. Since they act as “chemical sponges”, ion exchange resins are suited for the removal of contaminants from water and other liquids. This technology may offer a number of advantages in industrial water demineralization and softening, wastewater recycling, and other water treatment processes, including high water recovery, low volume of waste and operational flexibility. Ion exchange resins are also used in a variety of specialized applications such as chemical processing, pharmaceuticals, mining, and food and beverage processing.

The resin may be, for instance, in the form of a packed bed or a structured packing.

The resin is used to selectively remove ionic foulant species present in the produced water while leaving hardness (Ca²⁺, Mg²⁺) in the water, which can be removed in the polymeric membrane system.

Ion exchange resins are typically a matrix of cross-linked polystyrene molecules functionalized with acid (sulfonic, carboxylic, etc.) or basic (amino) groups. The functional group of the resin may be selected to adsorb specific ionic surfactant or macromolecule present in the water.

The resin may have strong acid or strong basic functional groups with a macroporous structure to absorb larger amounts of water and accommodate larger organic compounds. The resin may be mixed with other media (such as activated charcoal or walnut shells) to simultaneously remove other contaminants such as chlorine or other organic contaminants from the water.

The resin may be a cation exchange resin or an anion exchange resin.

The resin used in the examples described below is a strong acid cation exchange resin, DowexTM Marathon™ MSC resin (available from Dow Chemical Company, Midland, Mich., USA). The Dow Chemical Company describes this particular resin as a uniform particle size, high capacity, for industrial applications such as industrial softening and water demineralization. The matrix is macroporous styrene-DVB (divinylbenzene), and the functional group is sulfonic acid.

Reverse Osmosis

One type of polymeric membrane treatment is reverse osmosis (RO). Membrane processes are employed in produced water treatment for removal of particulates and dissolved species from the feed stream. Generally, there are four different membrane processes listed in order of decreasing pore size, namely Microfiltration (MF), Ultrafiltration (UF), Nanofiltration (NF) and Reverse Osmosis (RO). MF and UF membranes are used for the removal of fine particulates. RO membranes are effectively non-porous and therefore exclude dissolved solids such as organics and ionic species in the water to produce permeate with very low TDS, hardness and silica content.

RO uses an operating pressure higher than the osmotic pressure of the contaminant present in the liquid to filter the liquid through a membrane, thereby rejecting the contaminant.

Membranes may be metallic, polymeric or ceramic. Polymeric membranes are widely used in RO water treatment applications but ceramic membranes are generally limited to MF, UF and NF due to their high cost and limited performance capabilities in RO type applications. While ceramic membranes display a number of material advantages over polymeric in MF, UF, and NF applications, their use in RO applications is still under development. Hence, a pre-treatment step that mitigates the fouling limitation on flux performance of polymeric RO membranes is both technically and economically desirable.

As described above, following ion exchange, polymeric membranes may be used to treat the water.

An example of polymeric RO membranes are polyamide membranes. For instance, commercially available ESPA® (Energy Saving Polyamide), membranes may be used (as shown in the Examples below).

Fouling

The ionic nature of polymeric membranes and their interaction with water soluble ionic surfactants and organic macromolecules is understood to cause polymeric membrane fouling. In fact, a laboratory proof-of-concept study has established excessive membrane fouling of a polyamide composite membrane (with a net negative surface charge) in the presence of water soluble cationic surfactants. Resins according to the disclosure herein are purposed to mitigate fouling such as this.

Fouling Mitigation in the Membrane System Itself

Fouling mitigation may also be achieved within the membrane filtration system, for example, through generation of a high shear rate, for example, by high velocity cross-flow at the membrane surface or by mechanical enhancement through vibration, rotation, or oscillation. Fouling mitigation may also be assisted by, for instance, application-appropriate surface charge or a high degree of wetting (either hydrophobic or hydrophilic, depending on the transmitted phase).

One known high shear system is the VSEP (Vibratory Enhanced Shear Processing) system, manufactured by New Logic Research (Emeryville, Calif.). VSEP's separation technology is based upon an oscillating movement of the membrane surface with respect to the liquid to be filtered. The result is that binding of the membrane surface due to the build-up of solids is eliminated and free access to the membrane pores is provided to the liquid fraction to be filtered. The shear created from the lateral displacement causes suspended solids and colloidal materials to be repelled and held in suspension above the membrane surface. This combined with laminar flow of the fluid across the membrane surface keeps the filtered liquid homogeneous and allows very high levels of recovery of filtrate from the feed material. The VSEP system uses filtration membranes with torsional oscillation. An example of VSEP is described in U.S. Patent Publication No. 2007/0221575 (Copeland). Various types of anti-fouling, high shear membrane technologies are available in addition to VSEP, such as Spintek™, high velocity tubular, other rotating disk systems.

Pre-treatment

Between de-oiling and ionic exchange, a pre-treatment step may be used. In particular, the de-oiled water may be treated in an ultrafiltration or microfiltration unit with organic resistant polymeric membranes to partially remove dispersed or dissolved oil and solids. The pre-treatment polymeric membrane may be made from polytetrafluoroethylene (PTFE). The use of an organics resistant membrane may provide the benefit of reducing oil fouling on the resin.

### Examples

Table 1 provides the results of a laboratory proof-of-concept study using Dowex™ Marathon™ MSC resin (available from Dow Chemical Company, Midland, Mich., USA), and ESPA® (Energy Saving Polyamide) (available from Hydranautics, Oceanside, Calif., USA) in a vibrating RO set-up. The MSC resin is a highly cross-linked macroporous resin with high porosity and its functionality is particularly suited for a system containing oxidative species (e.g., residual reverse emulsion breaker which is polyfunctional, readily ionizable, and cationic in nature). The resin exhibits capabilities to enhance membrane performance and stabilize permeate flux by selectively removing cationic surfactants present in water. The ionic surfactant used in this study was Tetrolite Water Clarifier (RBW6302) available from Baker Hughes (Houston, Tex., USA). Better membrane performance and reduced cleaning frequency may be developed by optimization of resin loading and regeneration protocol.

TABLE 1
Results from lab-scale proof of concept study

| | RO permeate | RO permeate flux |
|---|---|---|
| | flux (ml/min; | (ml/min; corrected |
| | corrected to | to 50° C.; feed |
| | 50° C.); base | pretreatment with |
| | case, no feed-water | Dowex Marathon ™ |
| | pretreatment | MSC Resin |
| Initial membrane flux | 224 | 197 |
| with fresh water (FW) | | |
| FW + 50 ppm cationic | | |
| surfactant (RBW 6302) | | |
| t = 0 min | 185 | |
| t = 30 min | 166 | |
| t = 90 min | 133 | |
| t = 180 min | 102 | |
| t = 300 min | 84 (63% drop) | |
| FW + 1% NaC1 | | 166 |
| FW + 1% NaC1 + a | | |
| total of 35 ppm | | |
| of RBW6302 (25 ppm | | |
| batch + 10 ppm batch) | | |
| t = 301 min | | 121 (27% drop) |
| t = 503 min | | 116 |
| FW + 1% NaC1 + a | | |
| total of 145 ppm of RBW6302 | | |
| (25 ppm batch +11 dosages | | |
| of 10 ppm batch) | | |
| t = 781 min | | 111 (33% drop) |

Potential advantages of what is described herein may include:

1. Meet polymeric membrane feed-water specifications.

2. Enhance and/or stabilize the performance of a polymeric membrane system.

3. Mitigate polymeric membrane fouling, thereby reducing polymeric membrane cleaning frequency and/or polymeric membrane chemical addition requirements, and/or corrosion.

In the preceding description, for purposes of explanation, numerous details are set forth in order to provide a thorough understanding. However, it will be apparent to one skilled in the art that these specific details are not required.

The above description is intended to be examples only. The scope of the claims should not be limited by particular descriptions set forth herein, but should be construed in a manner consistent with the specification as a whole.

What is claimed is:

1. A process for treating de-oiled oilfield produced water or de-oiled process affected water from hydrocarbon production, comprising:
providing the de-oiled water; and
treating the de-oiled water with a regenerable polymeric ion exchange resin to selectively remove foulants that foul polymeric membranes, wherein the foulants comprise a water soluble ionic surfactant.

2. The process of claim 1, wherein the treating comprises ion-exchanging the water soluble ionic surfactant with a non-fouling soluble ionic species that can be removed by polymeric membranes.

3. The process of claim 2, wherein the non-fouling soluble ionic species comprises H⁺ or Na⁺.

4. The process of claim 1, wherein the resin is a cation exchange resin.

5. The process of claim 1, wherein the resin is an anion exchange resin.

6. The process of claim 1, wherein the resin is in the form of a packed bed.

7. The process of claim 1, wherein the resin is in the form of a structured packing.

8. The process of claim 1, further comprising, prior to providing the de-oiled water, de-oiling the oilfield produced water or the process affected water from hydrocarbon production, to produce the de-oiled oilfield water.

9. The process of claim 8, further comprising, prior to the de-oiling, adding a water soluble ionic surfactant to assist de-oiling.

10. The process of claim 1, further comprising, prior to the treating the de-oiled water with a regenerable polymeric ion exchange resin, treating the de-oiled water in an ultrafiltration or microfiltration vibrating unit with an organics resistant polymeric membrane to partially remove dispersed or dissolved oil and solids.

11. The process of claim 10, wherein the organics resistant membrane is made from a hydrophilic fluorocarbon polymer.

12. The process of claim 11, wherein the fluorocarbon polymer is polytetrafluoroethylene (PTFE) or polyvinylidene fluoride (PVDF).

13. The process of claim 1, wherein the polymeric membranes are reverse osmosis membranes.

14. The process of claim 1, wherein the polymeric membranes are nano-filtration membranes.

15. The process of claim 1, wherein the foulants further comprise a reverse emulsion breaker.

16. The process of claim 1, wherein the foulants further comprise organic macromolecules.

17. The process of claim 16, wherein the organic macromolecules comprise tannins, humic acids, fulvic acids, or a combination thereof.

18. The process of claim 1, wherein the de-oiled water has less than 30 mg/L oil.

19. The process of claim 1, wherein the de-oiled water has less than 15 mg/L oil.

20. The process of claim 1, wherein the water soluble ionic surfactant comprises a reverse emulsion breaker.

21. The process of claim 1, wherein the de-oiled produced water stems from an in-situ oil sands operation.
